(19) United States
(12) Patent Application Publication
(10) Pub. No.: US 2007/0210614 A1
(43) Pub. Date: Sep. 13, 2007

(54) Utility trailer

(76) Inventor: Noel Chandler, Naples, FL (US)

Correspondence Address: MORRISS OBRYANT COMPAGNI, P.C., 734 EAST 200 SOUTH, SALT LAKE CITY, UT, 84102, US

(21) Appl. No.: 11/716,874

(22) Filed: Mar. 12, 2007

Related U.S. Application Data
(60) Provisional application No. 60/781,119, filed on Mar. 10, 2006.

(51) Int. Cl. B62D 33/04

(52) U.S. Cl. 296/182.1

(57) ABSTRACT

A towable utility trailer is constructed of detachably attached component elements each of which is configured and structured with integrally formed frame elements that impart structural strength to the utility trailer. The component elements include a bottom, sides, one or more end panels and optional tailgate. The trailer also includes additional support beams that are detachably attached to the trailer body, and a towing device.

### CROSS-REFERENCE TO RELATED APPLICATION

This application is a non-provisional application claiming priority to provisional patent application Ser. No. 60/781,119 filed Mar. 10, 2006.

### BACKGROUND OF THE INVENTION

1. Field of the Invention

This invention relates to trailers of the type that are typically structured for being towed by a vehicle and in which cargo can be placed for transport. Specifically, this invention relates to a utility trailer that is constructed of multiple component elements that are detachably secured together.

2. Description of Related Art

Trailers are widely used for transporting cargo from place to place. Trailers are configured in numerous ways, but typically comprise a cargo holding area supported on one or more wheels. Trailers are conventionally non-motorized, but are structured to be towed by a powered vehicle, such as a truck or car, or even a bicycle. The cargo area may be open or enclosed, and the trailer may vary widely in size and holding capacity.

Typically, trailers may be constructed either in a unitary manner, such that the parts (e.g., the bed and sides, etc.) are principally formed of a single sheet of metal, or of parts that are permanently joined together by means such as welding. That is, the bed and sides of the trailer are separately formed but are joined together by a permanent welding process. Other parts of the trailer, such as wheel fenders and towing tongue, are also typically permanently welded to the rest of the trailer body.

While trailers of such conventional unitary and/or permanently welded construction are useful for their purposes, there are certain disadvantages that are inherent in such construction. For example, if some portion of the trailer becomes irreparably damaged, the trailer may become no longer useful for its purpose. Even if a repair can be made, the repair may be extremely costly as a result of trying to remove the damaged portion of the metal and re-welding in to place a new portion of the trailer.

Further, transport of unitarily formed trailers is very costly. That is, shipment of unitarily constructed trailers from the manufacturer to the retailer or other point of sale is expensive because fewer trailers can be loaded on the truck or trailer transporting the goods. An additional problem with unitarily formed trailers is that the trailer can typically only be made of one type of material, thereby resulting in a higher cost of manufacture.

It would be advantageous, therefore, to provide a trailer that is made of component parts that are detachably joined together by securement devices that enable the trailer to be assembled and disassembled for ease and cost-effectiveness of shipment, storage, repair and manufacture.

### BRIEF SUMMARY OF THE INVENTION

In accordance with the present invention, a towable utility trailer is constructed from modular or component elements that are detachably secured together with securement devices that enable the trailer to be assembled and disassembled as needed for shipment, storage, repair or replacement. The construction of the trailer also enables the trailer to be made of different materials, rather than a single type of material or metal, thereby enabling the utility and cost of the trailer to be specifically dictated by its intended use.

The trailer of the present invention is constructed of a bottom, sides and one or more end components that are each configured for detachable attachment to each other to form the trailer. The components are preferably each structured with integral structural framing elements that provide structural strength to the trailer and each of the individual components.

The component or modular construction of the trailer enables differently sized or dimensioned components to be joined together to construct different sizes of trailers. That is, different sizes of trailers may be built from an original design by being able to add components to enlarge the trailer or by selecting larger component parts, such as side panels.

The component or modular construction of the trailer further enables the trailer to be assembled from components that are made from different materials. Thus, for example, a trailer may be constructed from a bottom that is made of steel and sides that are made of aluminum, thereby providing a strong cargo base in a trailer that has a lighter weight construction overall. The particular application for which the trailer will be used will dictate what the component parts are made of. Additional strength may be added to the trailer by providing support members into which some kind of ballasting may be inserted.

The component or modular construction of the trailer of the present invention further enables the trailer to be shipped from the manufacturer to the retailer or end user in a more compact manner, thereby reducing shipment costs. Most importantly, the component or modular construction of the trailer enables the repair or replacement of only those components that are damaged or worn. Consequently, the service life of the trailer is considerably increased and costs are reduced.

### BRIEF DESCRIPTION OF THE SEVERAL VIEWS OF THE DRAWINGS

In the drawings, which currently illustrate the best mode for carrying out the invention:

FIG. 1 is a view in perspective of the utility trailer of the present invention;

FIG. 2 is a representational illustration of the relative positioning of the bottom and side panels of the trailer when disconnected from each other;

FIG. 3 is a representational illustration of the bottom and side panels of the trailer shown in FIG. 2, where the panels are joined and secured together;

FIG. 4 is a perspective view of the underside of the utility trailer;

FIG. 5 is a perspective view of the utility trailer illustrating the end gate in an open position; and

FIG. 6 is a perspective view of the utility trailer in an alternative embodiment.

### DETAILED DESCRIPTION OF THE INVENTION

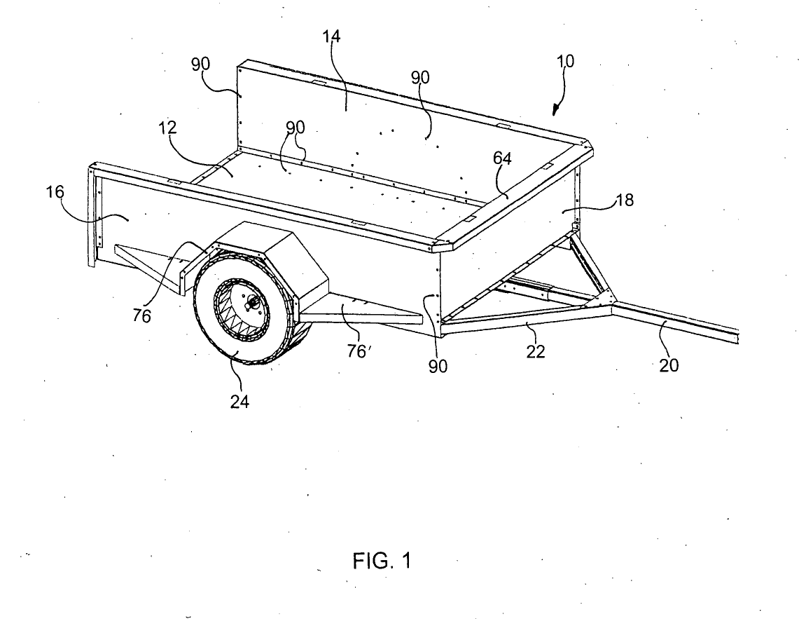

FIG. 1 illustrates the general configuration of the trailer of the present invention. The trailer generally comprises a trailer body 10 having a bottom 12, two side panels 14, 16 and a front panel 18. The trailer 10 further comprises a tongue 20 and tongue frame 22 for attaching the trailer to the hitch of a vehicle (not shown) for towing. The trailer 10 also includes wheels 24, the particular number of which may vary. The particular embodiment of the trailer body 10 shown in FIG. 1 is configured without a tailgate.

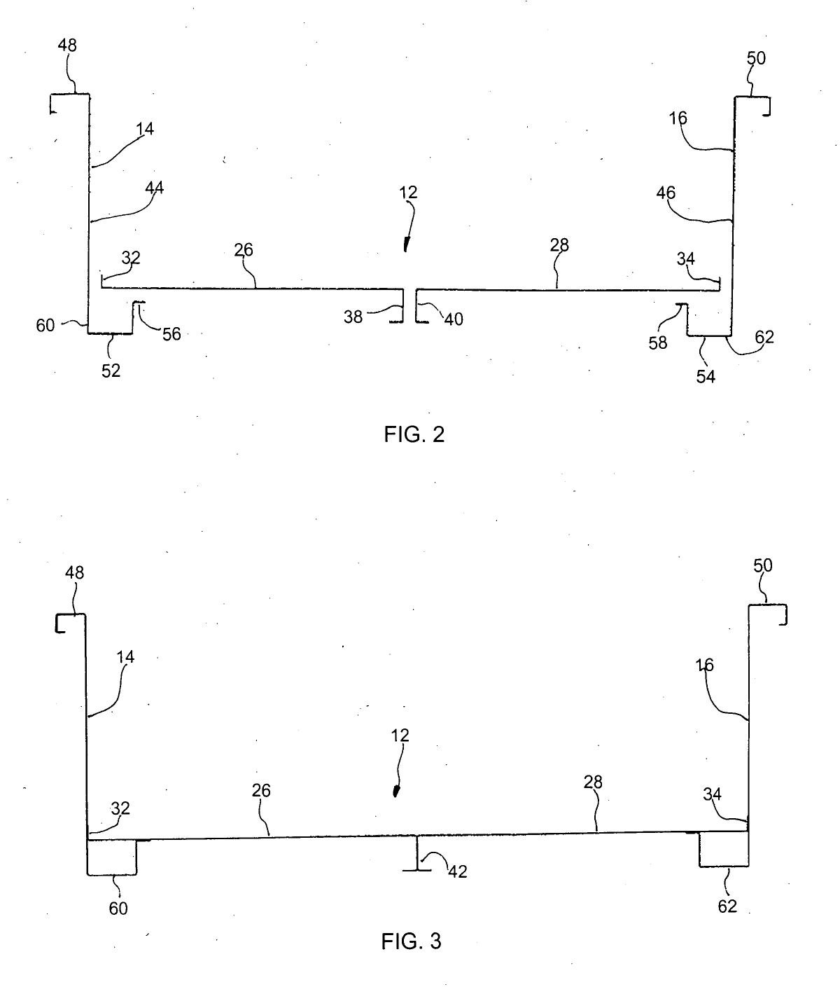

As best illustrated in FIG. 2, the bottom 12 of the trailer body 10 is preferably made of two long bottom panels 26, 28 that are joined together to form the bottom 12. The bottom 12 may comprise more than two panels, however. The two bottom panels 26, 28 may be sized in length, as shown representationally in FIG. 2, to extend the length of the trailer 10 or may be sized in length to extend the width of the trailer (i.e., from side panel 14 to side panel 16).

Each bottom panel 26, 28 has at its outside edge a flange 32, 34 that enables the two bottom panels 26, 28 to be secured to a respective adjacent side panel 14, 16. Each bottom panel 26, 28 is also formed at its inner edge with an L-shaped bend 38, 40 which enables the two bottom panels 26, 28 to be joined together, as illustrated further in FIG. 3. The L-shaped bend 38, 40 of the bottom panels 26, 28 provides the bottom 12 with an I-beam 42 (FIG. 3) construction which constitutes a part of the integrally formed frame of the trailer and which provides for structural strength in the trailer body 10.

Referring again to FIG. 2, each of the side panels 14, 16 is formed with an upstanding wall 44, 46 which may be oriented generally perpendicular to the bottom 12 of the constructed trailer 10. Each side panel 14, 16 is formed at its top end with an outwardly directed U-shaped bend that forms a longitudinal beam 48, 50 defining a part of the integral frame of the trailer body 10. The longitudinal beams 48, 50 provide structural strength to the trailer body 10.

Each side panel 14, 16 is also formed, at its bottom end, with a U-shaped bend 52, 54 and inwardly directed flange 56, 58 forming a U-shaped beam 60, 62 that runs the length of the side panel 14, 16. The U-shaped beam 60, 62 of each side panel 14, 16 further defines the integral frame of the side panels 14, 16 and the trailer 10 itself. The flange 56, 58 of each U-shaped beam 60, 62 provides the means by which the side panels 14, 16 are attached to the bottom panels 26, 28, as shown in FIG. 3.

The front panel 18 of the trailer 10 is configured in a manner similar to the side panels 14, 16 in that a U-shaped bend 64 (FIG. 1) is formed along the top end of the front panel 18 which defines an integral frame of that component, thereby providing structural strength to the trailer 10. The front panel 18 is also formed with an outwardly extending flange (not shown) that enables the front panel 18 to be attached to the bottom 12 and side panels 14, 16, as described more fully hereinafter.

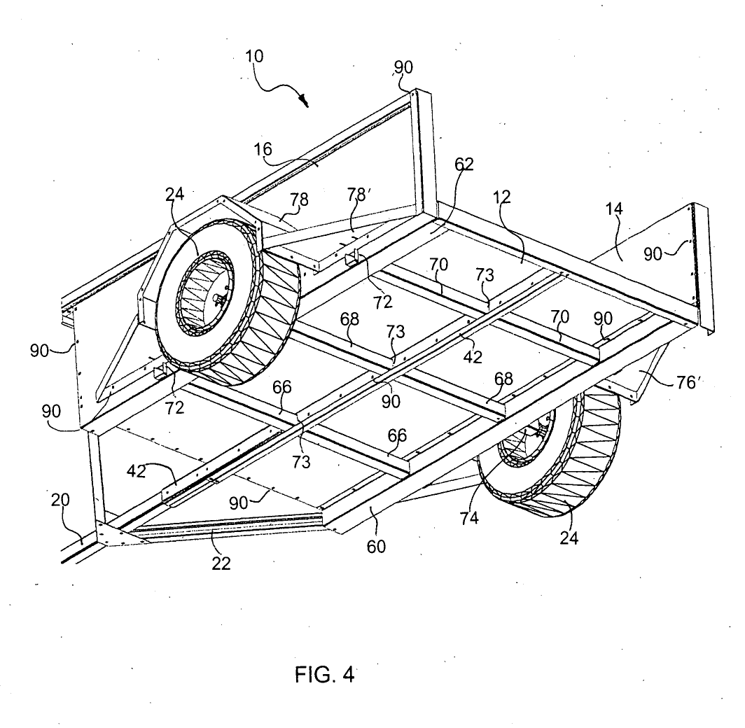

It can be seen from FIG. 4, which illustrates the underside of the trailer 10, that a plurality of square-shaped support beams 66, 68, 70 may be joined to the trailer 10 to increase the strength of the bottom 12. Each square-shaped support beam 66, 68, 70 is inserted through the respective tubular beam 60, 62 of the respective side panels 14, 16 through an appropriately sized opening 72 formed in the beams 60, 62, and is also inserted through an opening 73 formed in the I-Beam 42 of the bottom 12. The square-shaped support beams 66, 68, 70 are secured to the bottom 12 in the manner described more fully hereinafter. The number of square-shaped support beams may vary, but at least one square-shaped support beam 68 may be used as a channel through which the wheel axle 74 may pass.

It can also be seen from FIG. 4 that the tongue 20 may be attached to the I-Beam 42 of the bottom 12, while the tongue frame 22 is secured to the tubular beams 60, 62 of the trailer 10. Notably, the tongue 20 and tongue frame 22 may be structured to provide an amount of longitudinal adjustment of the tongue length relative to the bottom 12 of the trailer 10, thereby providing a selected distance between the trailer body 10 and the towing vehicle to which it is attached. The tongue 20 and tongue frame 22 may also be of hollow-beam construction, thereby allowing the tongue 20 and tongue frame 22 to be filled with an appropriate ballasting material. Likewise the support beams 66, 68, 70 may also be of hollow-beam construction to allow the support beams 66, 68, 70 to be filled with a ballasting material. Appropriate ballasting material might include, but not be limited to, sand, fluid, rocks, cement, or weighted foam. The U-shaped beams 60, 62 may also be filled with removable ballasting to add weight to the trailer body 10.

It is also illustrated in FIGS. 1 and 4 that the trailer 10 may include wheel fenders 76, 78 which extend about a portion of the wheel 24, and tree guards 76′, 78′ that are secured to the respective sides 14, 16 of the trailer 10. The particular design of the wheel fender 76, 78 and tree guards 76′, 78′ may vary from that shown, and the design may be selected to add particular strength to the trailer 10.

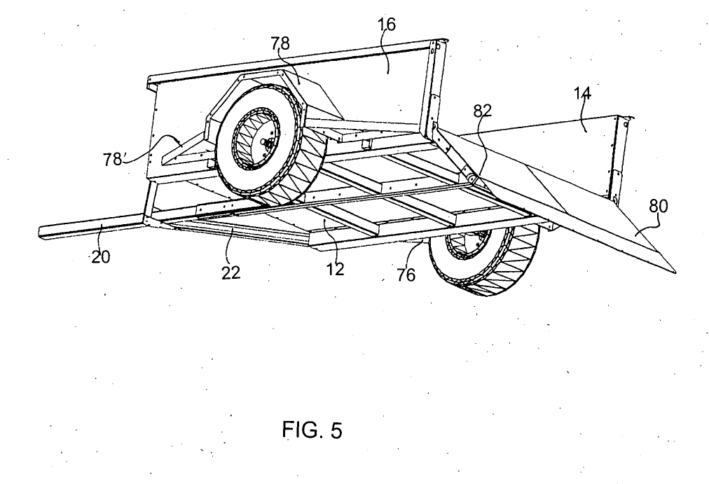

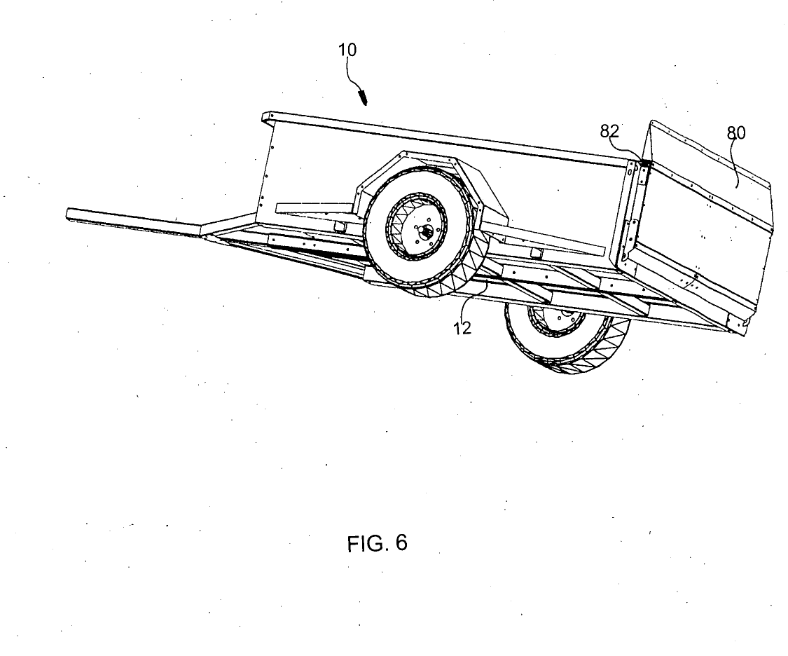

FIGS. 5 and 6 illustrate an alternative embodiment of the invention which includes a tailgate 80 that is pivotally attached to the side panels 14, 16 of the trailer body 10. The tailgate 80 may be configured in a manner similar to the side panels 14, 16, having U-shaped, or C-shaped, beams that provide an integral frame for the tailgate 80, as illustrated in FIGS. 5 and 6. The particularly illustrated construction of the tailgate 80 provides for a box-shaped tailgate 80 that adds strength to the component. One or more latching elements 82 may be provided on the tailgate 80 to secure the tailgate 80 to the side panels 14, 16 in a closed position as shown in FIG. 6.

As viewed in the figures, each of the component elements of the trailer 10, including the front panel 18, side panels 14, 16, bottom panels 26, 28, square-shaped support beams 66, 68, 70, tongue 20, tongue frame 22, wheel fenders 76, 78 and tailgate 80, are structured with a plurality of preformed holes 90 that, when appropriately aligned with respective holes in adjacent or adjoining component elements, enable the component elements to be secured together by appropriate securement devices, such as by bolts, screws, clasps or similar devices. The securement devices enable the component elements to be assembled and disassembled as desired.

The ability to secure the component elements together by means such as bolts enables the trailer to be shipped and stored in parts for later assembly, which reduces shipping costs and facilitates easy storage. Further, the component structure allows the trailer to be made of a variety of materials, such as, for example, aluminum, steel, galvanized steel, hardened plastics such as PVC, etc., that might not otherwise be usable because they are not conducive to being welded. The modular or component elements also allow the configuration of the trailer to be modified, or the size of the trailer to be modified to suit the particular use of the trailer. The modular elements of the trailer also allow just those components that are damaged to be replaced without having to sacrifice the whole trailer if just one component part is damaged.

The components of the trailer are generally cut from flat or plate material, such as steel, and are then formed by known processes to form the frame and other particular configurations as described and illustrated. One particularly suitable means of forming the frame aspects of the component elements is to use cold roll metal that is press-brake formed. This method provides particularly strong tubular configurations. To add additional strength to the frame elements, however, a ballasting material, such as concrete, can be inserted into the closed beams of the tongue, axle and support beams to increase their strength at minimal added cost to the trailer construction.

The modular trail of the present invention can be adapted for use in many types of applications. Those of skill in the art will appreciate the changes of configuration, size and dimension that may be required to adapt the basic trailer to a particular use. Therefore, reference herein to specific details of the trailer and the component elements are by way of example only and not by way of limitation.

What is claimed is:

1. A towable utility trailer, comprising a trailer body made of separate component elements that are each structured with integrally formed frame elements to impart structural strength to the trailer body, said trailer body having a bottom, sides and a towing element each being structured to attach to at least one other component element by securement devices that enable the component elements to be detachably attached to each other for assembly and disassembly of the trailer.

2. The towable utility trailer of claim 1 wherein said bottom of said trailer body is further comprised of two or more panels each being structured to be detachably attached to each other.

3. The towable utility trailer of claim 1 wherein said trailer body further comprises an end panel being structured with an integrally formed frame element, said end panel further being structured for detachable attachment to said sides and said bottom of said trailer.

4. The towable utility trailer of claim 3 wherein said sides are further comprised of side panels.

5. The towable utility trailer of claim 3 further comprising a tailgate.

6. The towable utility trailer of claim 1 wherein said trailer body further comprises structural support beams positioned along said bottom of said trailer and detachably attached to said bottom.

7. The towable utility trailer of claim 1 further comprising wheel fenders.

8. The towable utility trailer of claim 1 wherein one or more of said component elements is made of a different material than the other component elements of said trailer.

9. A utility trailer, comprising:
a trailer body formed of detachably attached component elements, said component elements further comprising:
a bottom;
two opposing sides; and
a towing element;
wherein said bottom and said two opposing sides are configured and structure with integrally formed frame elements that impart structural strength to said trailer.

10. The utility trailer of claim 9 wherein said bottom further comprises two or more separate panels detachably attached to each other, one or more of which are structured with integrally formed frame elements.

11. The utility trailer of claim 9 further comprising at least one end panel component element detachably attached to said sides and bottom, said at least one end panel being configured and structured with integrally formed frame elements.

12. The utility trailer of claim 11 further comprising a tailgate component element detachably attached to said bottom.

13. The utility trailer of claim 9 further comprising one or more support beams detachably attached to said bottom of said trailer body.

14. The utility trailer of claim 11 further comprising wheel fenders.

15. The utility trailer of claim 1 wherein one or more of said component elements is made of a different material than the other component elements of said trailer.

16. The utility trailer of claim 11 wherein one or more of said component elements is made of a different material than the other component elements of said trailer.

17. The utility trailer of claim 9 further comprising ballasting material inserted in portions of said integrally formed frame elements to add weight to said trailer body.
